(19) United States
(12) Patent Application Publication
(10) Pub. No.: US 2016/0090847 A1
(43) Pub. Date: Mar. 31, 2016

(54) COOLING SCHEME FOR A TURBINE BLADE OF A GAS TURBINE

(71) Applicant: ALSTOM Technology Ltd, Baden (CH)

(72) Inventor: Sergey SHCHUKIN, Mellingen (CH)

(21) Appl. No.: 14/858,285

(22) Filed: Sep. 18, 2015

(30) Foreign Application Priority Data
Sep. 26, 2014 (EP) 14186560.0

(51) Int. Cl. F01D 5/18

(52) U.S. Cl. CPC F01D 5/187; F05D 2220/32; F05D 2240/303; F05D 2260/201; F05D 2250/71

(57) ABSTRACT

A turbine blade of a gas turbine includes a radially extending airfoil with a suction side and pressure side, which extend each in axial direction between a leading edge and a trailing edge of the airfoil. The leading edge is cooled by means of impingement cooling with rows of radially distributed jets of a cooling medium impinging on the inner side of the leading edge. The row of radially distributed jets is generated at an internal web, which divides the hollow interior of the airfoil into first and second cavities, with the second cavity being arranged at the leading edge. An enhanced cooling is achieved by the internal web that includes two rows of radially distributed cooling medium supply holes, through which cooling medium enters the second cavity in form of impinging jets. The cooling medium supply holes are oriented such that the directions of the jets of one row cross the directions of the jets of the other row.

### CROSS-REFERENCE TO RELATED APPLICATIONS

This application claims priority to European Patent Application 14186560.0 filed Sep. 26, 2014, the contents of which are hereby incorporated in its entirety

### TECHNICAL FIELD

The present invention relates to the technology of gas turbines. It refers to a turbine blade of a gas turbine according to the preamble of claim 1.

### BACKGROUND

FIG. 6 shows in a perspective view an example of a turbo machine in form of a gas turbine of the applicant of type GT24 or GT26. The gas turbine 30 of FIG. 6 comprises a rotor 31 rotating around a machine axis and being enclosed by an (inner) casing 32. Arranged along the machine axis the gas turbine 30 comprises an air intake 33, a compressor 34, a first combustor 35, a first, high pressure (HP) turbine 36, a second combustor 37, a second, low pressure (LP) turbine 38 and an exhaust gas outlet 39.

In operation, air enters the machine through air intake 33, is compressed by compressor 34, and is fed to first combustor 35 to be used to burn a fuel. The resulting hot gas drives HP turbine 36. As it still contains air, it is then reheated by means of second combustor 37, where fuel is injected into the hot gas stream. The reheated hot gas then drives LP turbine 38 and leaves the machine at exhaust gas outlet 39.

The turbine stages of such a gas turbine are exposed to very high temperatures and therefore have to be cooled effectively. FIG. 1 shows a turbine stage 28 of a gas turbine 10 with a ring of stationary vanes 13 and a ring of rotating turbine blades 12. When a stream of hot gas 14 flows through said turbine stage 28, especially the leading edge 24 of the blade 12 is exposed to hot gas and has to be cooled.

Existing solutions disclose a blade leading edge (LE) cooling provided either by means of (1) a cooling medium radial flow with following shower head cooling (ordinary casting process) or by (2) impingement cooling through one row of supply air holes (ordinary casting) or by (3) impingement cooling through two rows of holes (soluble core to be applied).

Solution (1) does not provide high effective convection cooling (compared to impingement) and is weak in terms of pressure margin in particular at the airfoil tip.

Solution (2) is effective in terms of convection cooling, but provides the highest convective HTC in a region of stagnation point where the shower head already provides necessary wall temperature.

Solution (3) avoids disadvantages of solution (1) and (2), but is too expensive in manufacturing (casting) and still does not provide an optimum angle between the cooling jets and airfoil wall internal surface.

U.S. Pat. No. 3,806,275 discloses a hollow air-cooled turbine blade, which has a web extending from face to face of the blade to divide the interior of the blade into two spanwise-extending chambers. A thin sheet metal liner is disposed in each chamber, the liner having perforations distributed over its surface and having projections to space it from the blade wall. The liner is flexible and may be folded substantially flat for insertion into the end of the blade. At the leading edge of the blade, the liner walls are recurved to define a generally parallel-walled slot nozzle extending spanwise of the blade. Additional holes are placed along the outlet from this nozzle to flow additional air for entrainment by the jet emerging from the slot nozzle to improve cooling of the leading edge. Cooled air enters the liners through the blade stalk and is discharged preferably through the tip and trailing edge of the blade.

Document EP 2 228 517 A2 is related to a baffle insert for an internally cooled airfoil. The baffle insert comprises a liner, a divoted segment and a plurality of cooling holes. The liner has a continuous perimeter formed to shape of a hollow body having a first end and a second end. The divoted segment of the hollow body is positioned between the first end and the second end. The plurality of cooling holes is positioned on the divoted segment to aim cooling air exiting the baffle insert at a common location.

According to U.S. Pat. No. 6,168,380, in a cooling system for the leading-edge region of a hollow gas-turbine blade, a duct extends inside the thickened blade leading edge from the blade root up to the blade tip. The duct, via a plurality of bores made in the blade leading edge, communicates with a main duct, through which the cooling medium flows longitudinally, and the flow through the duct occurs longitudinally over the blade height, and the duct is formed with a variable cross section. The cross section of the duct increases continuously in the direction of flow of the cooling medium from the blade root up to the blade tip. In the case of blades having a cover plate, the duct merges at its top end into a chamber, which is mounted below the cover plate and is in operative connection with a pressure source, the pressure of which is lower than the pressure in the main duct.

### SUMMARY

It is an object of the present invention to provide a cooling scheme for the leading edge of a turbine blade, which avoids the disadvantages of existing leading edge cooling designs.

This and other objects are obtained by a turbine blade according to claim 1.

The turbine blade according to the invention comprises a radially extending airfoil with a suction side and pressure side, which extend each in axial direction between a leading edge and a trailing edge of said airfoil, whereby said leading edge is cooled by means of impingement cooling with rows of radially distributed jets of a cooling medium impinging on the inner side of said leading edge, and whereby said row of radially distributed jets is generated at an internal web, which divides the hollow interior of the airfoil into first and second cavities, with the second cavity being arranged at said leading edge.

It is characterized in that said internal web comprises two rows of radially distributed cooling medium supply holes, through which cooling medium enters said second cavity in form of impinging jets, and that said cooling medium supply holes are oriented such that the directions of said jets of one row cross the directions of said jets of the other row.

According to an embodiment of the invention said internal web has a curved cross section profile, which is convex with respect to the second cavity.

Specifically, said web has a curved cross section profile with a constant radius of curvature (R1, R2).

Alternatively, said web has a curved cross section profile with a ‘snake head’ shape.

According to another embodiment of the invention said first row of radially distributed cooling medium supply holes is arranged near the suction side of said airfoil and the jets formed by said holes impinge on the pressure side of said leading edge, whereby said second row of radially distributed cooling medium supply holes is arranged near the pressure side of said airfoil and the jets formed by said holes impinge on the suction side of said leading edge.

According to just another embodiment of the invention said holes of said first row and said holes of said second row have an offset in radial direction with respect to each other.

According to a further embodiment of the invention said leading edge has a shower head configuration with a plurality of cooling holes, through which the said impingement cooling medium is ejected to the outside of said airfoil.

### BRIEF DESCRIPTION OF THE DRAWINGS

The present invention is now to be explained more closely by means of different embodiments and with reference to the attached drawings.

FIG. 1 shows a turbine stage of a gas turbine with a ring of stationary vanes and a ring of rotating turbine blades;

FIG. 2 shows a cross section of the airfoil of a rotating turbine blade according to FIG. 1 with a leading edge cooling scheme according to an embodiment of the invention;

FIG. 3 shows in more detail the leading edge cooling scheme of FIG. 2;

FIG. 4 shows a variant of the leading edge cooling scheme of FIG. 3, which design is possible to introduce in the ordinary casting process with no use of soluble core;

FIG. 5 shows a longitudinal section of the airfoil of FIG. 2 or 3 showing the radial offset between the suction side and pressure side impingement holes;

FIG. 6 shows in a perspective view an example of a high temperature gas turbine of the applicant of type GT24 (with sequential combustion).

### DETAILED DESCRIPTION

The present invention provides a cooling heat transfer enhancement at turbine blade leading edge area by means of an impingement cooling scheme application, thereby utilising the cooling medium (e.g. air) heat capacity.

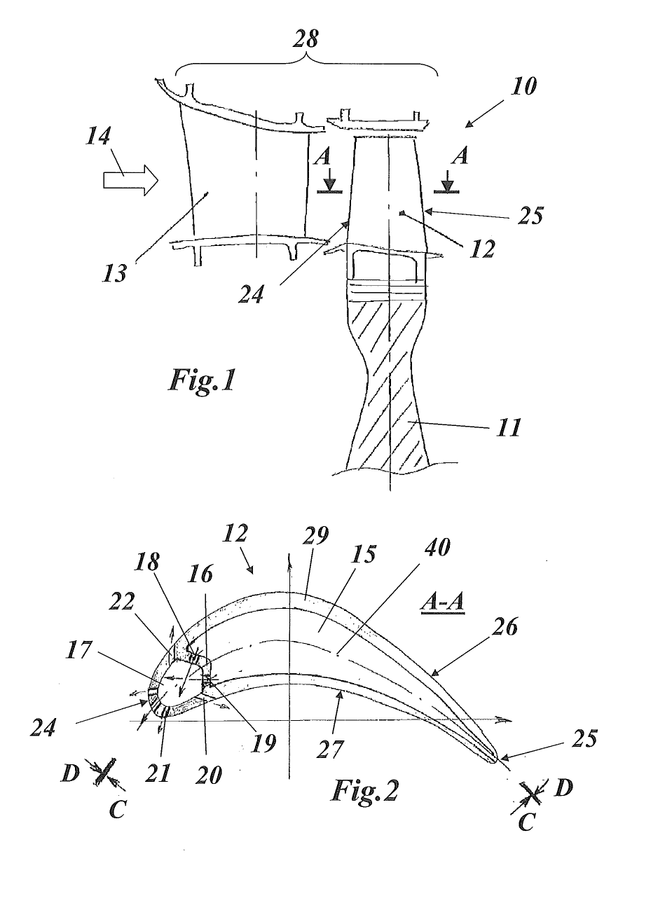

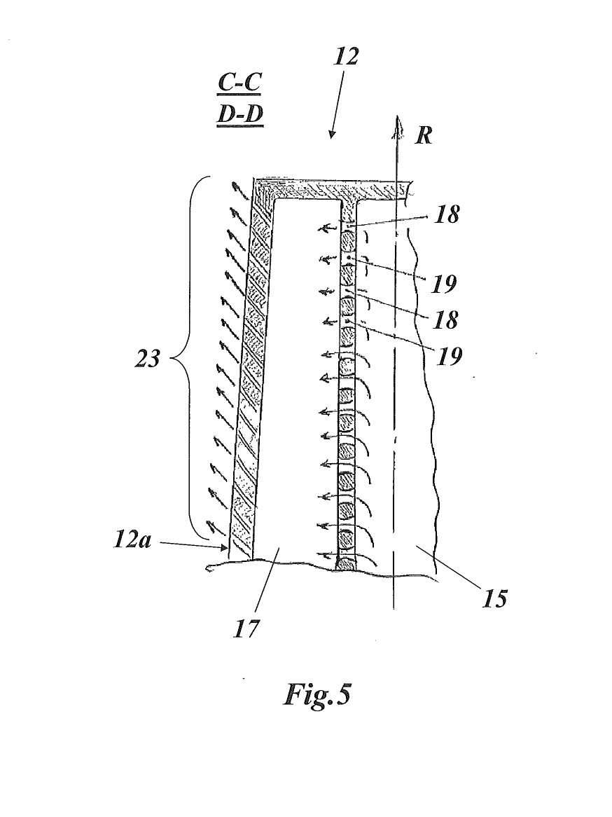

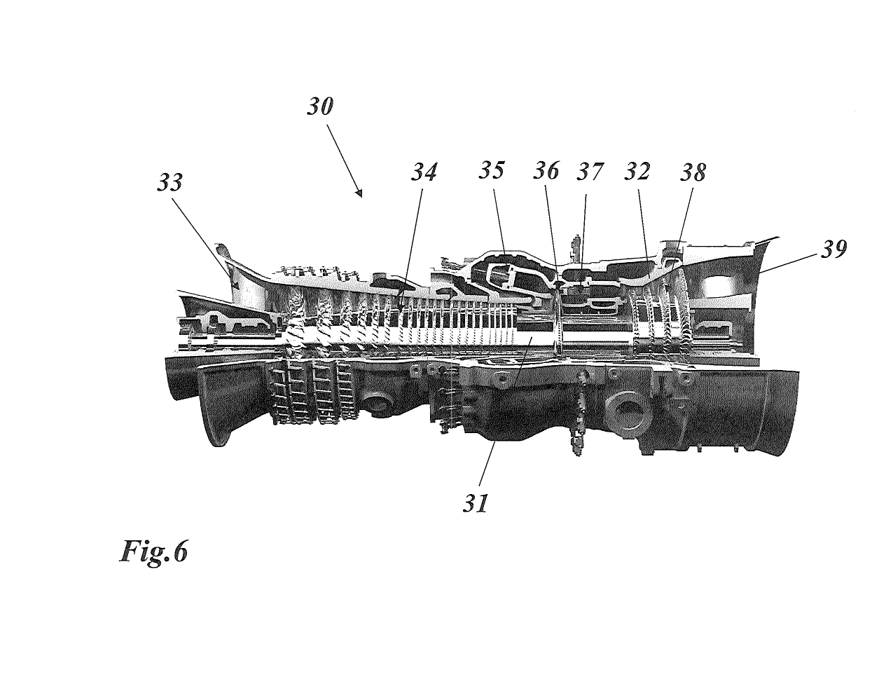

FIG. 2 shows a cross section of the airfoil 29 of a rotating turbine blade 12 according to FIG. 1 with a leading edge cooling scheme according to an embodiment of the invention. The airfoil 29 has a leading edge 24 and a trailing edge 25. The airfoil 29 further has a suction side 26 and a pressure side 27. A chord 40 characterizes the profile of the airfoil 29. The hollow interior of the airfoil 29 is divided into a first and second cavity 15 and 17, respectively, by means of an internal web 16. Cooling medium enters the first cavity 15 from the root of the blade 12 in radial direction R (see FIG. 5).

The internal web 16 is provided with two rows of cooling medium supply holes 18 and 19, respectively, through which the cooling medium flows from the first cavity 15 into the second cavity 17, thereby generating impingement jets of crossing directions towards the pressure side 27 and suction side 26, respectively. The orientation of the holes 18 and 19 is such that a first row of radially distributed cooling medium supply holes 18, which is arranged near the suction side 26 of airfoil 29 forms jets, which impinge on the pressure side 27 of leading edge 24, while the second row of radially distributed cooling medium supply holes 19 is arranged near the pressure side 27 of said airfoil and forms jets, which impinge on the suction side 26 of said leading edge 24.

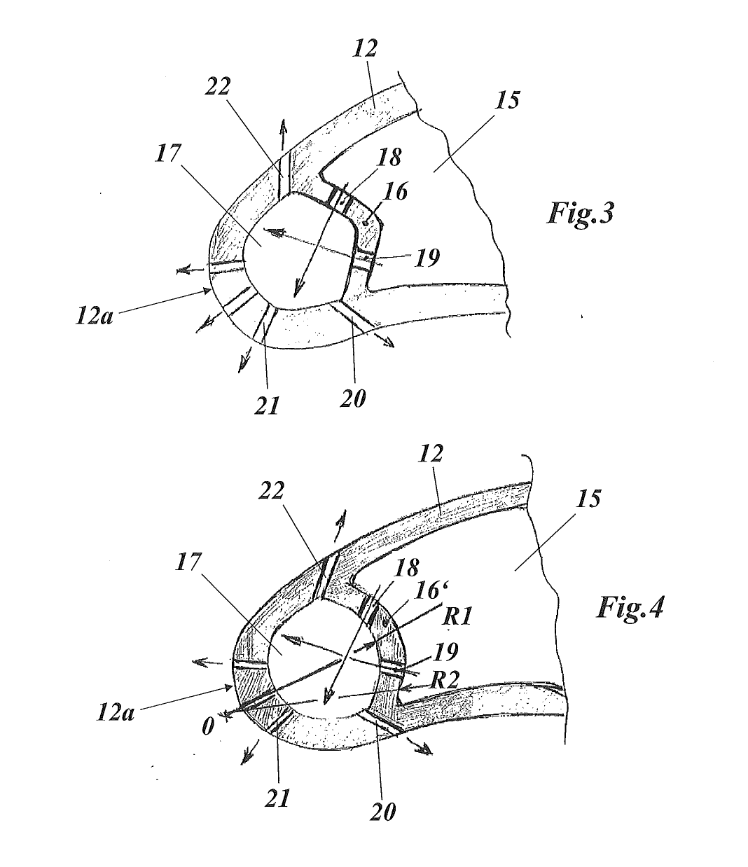

According to the embodiment shown in FIGS. 2 and 3, internal web 16, where those holes 18 and 19 are placed, has a cross section profile with the shape of ‘snake head’. The holes 18 and 19 are placed on both sides of the chord 40. The angle between the impingement flows from holes 18 and 19 and the wall internal surface in this case is close to optimal in terms of cooling effectiveness. The ‘snake head’ shape can be easily produced by a metal laser sintering process (SLM). However, it is not possible to produce it by an ordinary casting process.

FIG. 4 shows a variant, where the internal web 16′ has a cross section profile in form of a section of a cylindrical wall with constant radius' of curvature R1 and R2. Such design is possible to introduce into the ordinary casting process with no necessity to use a soluble core,

According to FIG. 5 an offset in radial direction between the impingement holes 18 and 19 is preferred, wherein every hole 18 in a row placed close to suction side 26 has an offset in radial direction with hole 19 placed in a row close to pressure side 27. Leading edge 24 has a shower head configuration 23 with a plurality of cooling holes 20, 21 and 22, through which the impinged cooling medium is ejected to the outside of airfoil 29.

1. A turbine blade of a gas turbine comprising a radially extending airfoil with a suction side and pressure side, which extend each in axial direction between a leading edge and a trailing edge of said airfoil, whereby said leading edge is cooled by means of impingement cooling with rows of radially distributed jets of a cooling medium impinging on the inner side of said leading edge, and whereby said row of radially distributed jets is generated at an internal web, which divides the hollow interior of the airfoil into first and second cavities, with the second cavity being arranged at said leading edge, wherein said internal web includes two rows of radially distributed cooling medium supply holes, through which cooling medium enters said second cavity in form of impinging jets, and that said cooling medium supply holes are oriented such that the directions of said jets of one row cross the directions of said jets of the other row.

2. The turbine blade as claimed in claim 1, wherein said internal web has a curved cross section profile, which is convex with respect to the second cavity.

3. The turbine blade as claimed in claim 2, wherein said web has a curved cross section profile with a constant radius of curvature (R1, R2).

4. The turbine blade as claimed in claim 2, wherein said web has a curved cross section profile with a ‘snake head’ shape.

5. The turbine blade as claimed in claim 1, wherein said first row of radially distributed cooling medium supply holes is arranged near the suction side of said airfoil and the jets formed by said holes impinge on the pressure side of said leading edge, whereby said second row of radially distributed cooling medium supply holes is arranged near the pressure side of said airfoil and the jets formed by said holes impinge on the suction side of said leading edge.

6. The turbine blade as claimed in claim 1, wherein said holes of said first row and said holes of said second row have an offset in radial direction with respect to each other.

7. The turbine blade as claimed in claim 1, wherein said leading edge has a shower head configuration with a plurality of cooling holes, through which the impinged cooling medium is ejected to the outside of said airfoil.
